(19) United States
(12) Patent Application Publication
(10) Pub. No.: US 2013/0127127 A1
(43) Pub. Date: May 23, 2013

(54) SPECIAL WORK AND REST CHAIR, INTENDED TO BE USED FOR PEOPLE (ESPECIALLY FOR CHILDREN) WITH LOCOMOTOR DISABILITY, PARTICULARLY IN CASE OF CEREBRAL PARALYSIS (PALSY)

(71) Applicants: Remigijus Vainutis, Vilnius (LT); Martynas Vainutis, Vilnius (LT)

(72) Inventors: Remigijus Vainutis, Vilnius (LT); Martynas Vainutis, Vilnius (LT)

(73) Assignee: KASKO GROUP. UAB, Vilnius (LT)

(21) Appl. No.: 13/816,183

(22) PCT Filed: Mar. 9, 2011
(86) PCT No.: PCT/IB2011/050984

§ 371 Date: Feb. 8, 2013

(30) Foreign Application Priority Data
Aug. 10, 2010 (LT) 2010 057

(51) Int. Cl. A61G 5/10

(52) U.S. Cl. CPC A61G 5/10
USPC 280/47.4; 297/311

(57) ABSTRACT

The aim of this invention is creating a chair for children work, rest, training and rehabilitation in the sitting position. The chair is suitable for people suffering from cerebral paralysis, paraplegia, paraparesis, tetraplegia, tetraparesis, as well as after violation of the spinal—in the area of the neck, chest and waistline. The basis of this chair is made of a double frame construction and worm shaft adjustment mechanism, which ensure smooth and precise turn of the chair position/change from sitting/working position to half (more or less) lying rest position or vice versa.

This double frame construction and worm shaft adjustment mechanism ensure construction stability, safety, even (smooth) change of positions, precision, efficiency and long service time. The double frame construction consists of the external and internal frames, which, when using the mentioned worm shaft adjustment mechanisms, can be moved relatively to each other. In the construction there are no spring-based or mechanical retainers, reducing the efficiency of the construction. All/most of the parts of the construction are made of wood and create a pleasant and calming effect for a child with locomotor disability.

### FIELD OF INVENTION

This invention is related to chairs, intended for people (persons) with locomotor disability, especially in case of cerebral paralysis (palsy). The purpose of this chair is resting (especially for children) or sitting and/or working in front of a desk. This chair, intended to be used for children work and rest, training and rehabilitation in the sitting position, is suitable in case of cerebral paralysis (palsy), paraplegia, paraparesis, tetraplegia, tetraparesis, as well as after violation of the spinal—in the area of the neck, chest and waistline.

### BACKGROUND OF INVENTION

From the old days people construct and use chairs, intended for people with disabilities, including the cases of cerebral paralysis and the cases mentioned above. There are many chairs of various constructions created and patented in this field, aimed for sitting, working changing position, moving and resting. However, as the time passes and new needs or requirements arise, new types of before mentioned chairs are created, which better satisfy people needs and have new qualities, as well as exclusive constructions.

There are known Chinese patent No CN2606581, published on Mar. 17, 2004. This patent describes a multifunctional folding chair, the basis of which consists of Y-form folding frame, made of the main and the additional frames. A person is able to sit in this chair and move in the preferable direction, however, the chair is not comfortable for resting because it cannot be reclined, as well as it is inconvenient for working in front of a desk because of a considerable distance between the person and the desk.

Also there are known U.S. Pat. No. 3,992,057, which was published on Sep. 25, 1973. This patent describes a chair for children, intended for children suffering from cerebral paralysis. The chair has a seat, backrest, armrests and abduction (restraint) device, the position of which can be changed. This chair differs from the ordinary children chair only in the aspect it has an adjustable abduction (restraint) device, its construction, however, does not allow the variable sitting position of the chair.

One more known U.S. Pat. No. 4,145,082 was published on Mar. 20, 1979. This patent describes a chair for a child, having an abduction (restraint) device of a special form, which restraints the movement of legs not only in the horizontal direction, but also enfolds child legs from the top, not letting them to cross, etc. Nevertheless, the seat of this chair is stationary as well.

Also there are known Japanese patent No JP2003325584 that was published on Nov. 18, 2003. This patent describes a chair, intended for people with disabilities. Position of the seat of the chair can be changed, i.e. it can be retracted, obtruded, bended up or down. The position is changed due to a special hand-operated or motor-operated construction. The ability to change positions is useful when a person is sitting in front of a desk. When changing the chair position, the angle between the basis of the seat and the wall of the backrest changes, which is usually unwanted. Moreover, when changing the previously mentioned angle, the sitting position of a person becomes strained and tiring.

The closest (nearest) patent according to the technical level is U.S. Pat. No. 4,145,083, published on Mar. 20, 1979. The chair described in this patent, intended for people with disabilities, can change its position without changing the angle between the basis of the seat and the wall of the backrest, i.e. turn in a certain angle in respect of the connecting axle of the seat and backrest wall, the size of which depends on the arched constructional fixative element, keeping the plane of chair seat in the lifted position. In this way the chair can have a few positions, corresponding to work and rest positions. However, this chair has a few drawbacks. First one is that the above mentioned arched constructional fixative element can only be fixed in two positions, i.e. the change of the chair position has not even (smooth), but discrete character. Furthermore, this chair has two strictly defined positions. The other drawback is that only a person standing close to the chair can change its position. Changing the position of the chair for the person with disability is extremely difficult or even impossible. It is also known that retainers, fitted in any of the systems, normally are the weaknesses of the construction, which usually do not serve the purpose: badly lock, do not unlock, unlock not on time, etc.

### SUMMARY OF THE INVENTION

The aim of this invention is to create a comfortable, pleasing to the eye as well as to the body/skin, mobile, inexpensive, well-operated and easily manufactured chair, intended for children with locomotor disability, especially in case of cerebral paralysis (palsy) and the other above mentioned cases.

The most exclusive feature of this invention is that the basis of the construction of this chair consists of double frame construction, which ensures correct and even (smooth) turn of the chair position/change the position from sitting/working to (more or less) lying/resting or vice versa. The construction also ensures exact and even (smooth) adjustment of the depth level of the sitting part of the chair, as well as exact and even (smooth) adjustment of the footstool height. This double frame construction as well as the integrated and specially adjusted worm shaft mechanism, regulating the chair position and sitting part length, allows smoothly and precisely adjust chair position according to the needs. Also the double frame construction, worm shaft adjustment and position fixing mechanism ensure construction stability and safety as well as even (smooth) change of positions, efficiency and long service time without repair and other adjustment works. Double frame construction consists of external and internal frames, which, after integrating the previously mentioned worm shaft adjustment mechanism, can move relatively to each other. Construction also offers a possibility of precise and easy adjustment of the footstool height and many more fixation possibilities, for example, in the level of foot, hips, chest, head or neck. This construction does not include any springs or mechanical retainers that would reduce the efficiency of the construction. All/most of the construction elements, which may come into contact with people body/skin, are made of natural wood and create a pleasant and calming effect for a child with locomotor disability.

### BRIEF DESCRIPTION OF THE DRAWINGS

FIG. 1 shows a general sectional view of the work and rest chair, intended for children with locomotor disability.

FIG. 2 is a photograph of the work and rest chair (view from the rear side of the chair), where the view of the worm shaft adjustment mechanism of the work and rest chair is provided, which ensures even (smooth) turn of the chair position/change of sitting/working half lying/resting position and vice versa; as well as the worm shaft mechanism, intended for adjustment of the sitting part depth.

FIG. 3 is a photograph of the work and rest chair, where it is possible to see the belts for holding or fixing the body parts of a person, also there are shown the appropriate holders which support the body of the person (child) from the sides: head and torso.

### DESCRIPTION OF THE PREFFERED EMBODIMENT

As it is known, there are many chairs of various types currently created in the world that are intended for people with locomotor disabilities. Normally, the type of a chair construction depends on the type/group/subgroup of disability the person has. Due to the variety of the disabilities, the chairs are not always comfortable and do not always suit the needs of the persons in the constructional aspect. Moreover, the chairs are usually made of plastic, metal or unnatural substances.

The aim of this invention is to create a comfortable, pleasant to the eye and body/skin, mobile, inexpensive, well-operated and easily manufactured chair, intended for children with locomotor disabilities, especially in case of cerebral paralysis and the other above mentioned cases. One of the aspects of this invention is that plenty of the elements of this chair are made of natural wood, therefore it is easy to take care of this chair as well as it is pleasant to touch it. Furthermore, the chair creates a pleasant and calming effect for a child with locomotor disability. However, the main difference of this invention is its construction.

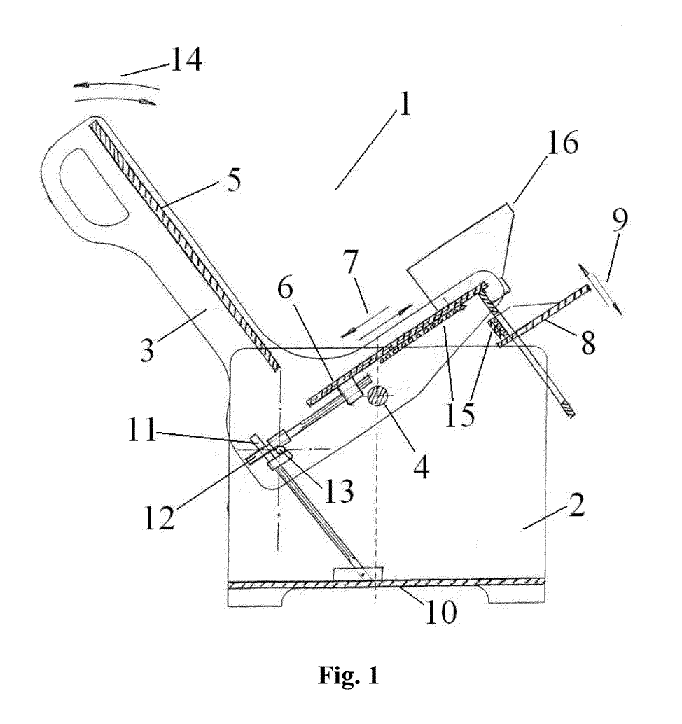

FIG. 1 shows a general sectional view of work and rest chair, intended for children with locomotor disability. The basis of this chair (1) consists of double frame and worm shaft adjustment mechanisms. Double frame is made of stationary, immobile external chair frame (2) and internal chair frame (3) that can move relatively to the external frame. The external frame (2) is put on the ground and it functions as a chair basis. Wheels can be mounted to the bottom part of the external frame (2), intended for moving the chair (1) to the desirable direction. When using the main connecting axle (4), the external frame (2) is connected with the internal frame (3), which can be rotated around the mentioned main connecting axle (4). On the internal chair frame (3) the backrest (5) and the sliding (changes the sitting depth) sitting part/seat (6) are mounted. The latter is adjusted (7) according to the height/build of the person. The angle of 90°, the angle close to 90° or other variable or stationary angle according to the medical or other requirements is kept between the chair seat (6) and the plane of the backrest (5), also between the chair seat (6) and the vertical part of the footstool, as well as between the vertical and horizontal (moving) parts of the footstool. Besides, a footstool (8) is mounted to the internal chair frame (3), which is adjusted (9) according to the height/build of the person. To ensure the rotation of the mentioned internal frame (3) around the connecting axle (4) and the possibility to adjust the depth of the sitting part (6), worm shaft adjustment mechanisms are integrated to the chair construction, consisting of a stationary connecting part (10), vertical worm shaft (11) and horizontal worm shaft (12). Stationary horizontal connecting part (10), mounted to the external stationary chair frame (2), functions as a bearing for the vertical worm shaft (11) with which it is connected using a corresponding swivel. In this way the mentioned vertical worm shaft (11) is connected with the stationary connecting part (10) and the axle (13) of the internal frame (3), while the horizontal worm shaft (12) is connected with the internal chair frame (3) through the axle (13) and the seat (6) using the swivels. There is the axle (13) of the internal frame mounted between the vertical worm shaft (11) and the horizontal worm shaft (12), acting as a bearing for the worm shafts (11, 12). When rotating the vertical worm shaft (11) around its axle, depending on the rotating direction, it starts smoothly moving forth or back, making the position of the internal chair frame (3) be changed and fixed in respect of the external chair frame (2) through the axle (4). Since the internal chair frame (3) is connected with the chair seat (6), backrest (5) and the adjustable footstool (8), when rotating the vertical worm shaft (11), the position of the chair (1) constantly changes (14) from the sitting/work position to the half (more or less) lying rest position. When rotating the horizontal worm shaft (12) around its axle, depending on the rotating direction, it starts smoothly moving forth or back, making the position of the seat (6) to be changed (7) and fixed in respect of the backrest (the seat depth increases or decreases in respect of the same backrest). Retaining mechanisms (15) are mounted in the front part close to the footstool (8) in respect of the internal frame (3) of the chair (1). These mechanisms ensure easy and even (smooth) change of the footstool (8) and seat (6) positions.

The smooth movement of the sliding parts is ensured not only by the worm shaft adjustment mechanism, but also by the guides (18), on which all other sliding parts of the construction are mounted. The mentioned guides (18) can be made of metal or other solid material.

The construction also has a removable abduction (restriction) device (16), intended for keeping child legs in the proper position/place.

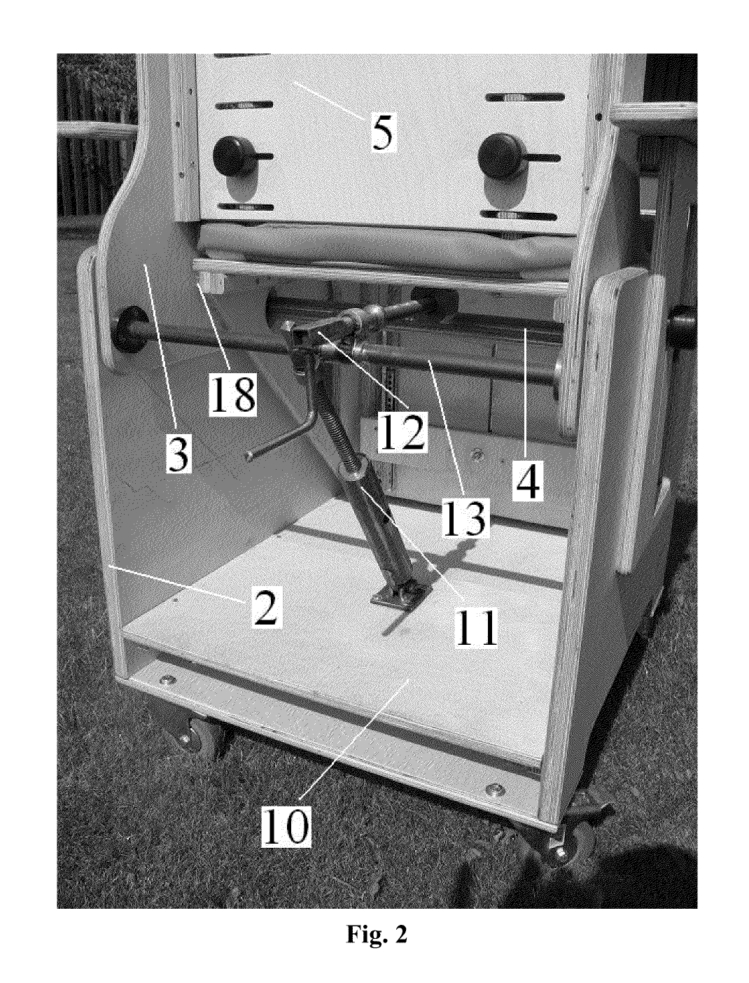

FIG. 2 shows worm shaft adjustment mechanisms of work and rest chairs (1), ensuring even (smooth) and exact turn of chair backrest (5) with the sitting part (6) and the footstool (8) position/change from sitting/work position to half lying/rest position and vice versa, as well as adjustment of sitting part depth. The chair position can be changed by the person standing close to the chair or by the person (child) sitting in the chair using the corresponding engines, additional mechanics, electronics and console(s).

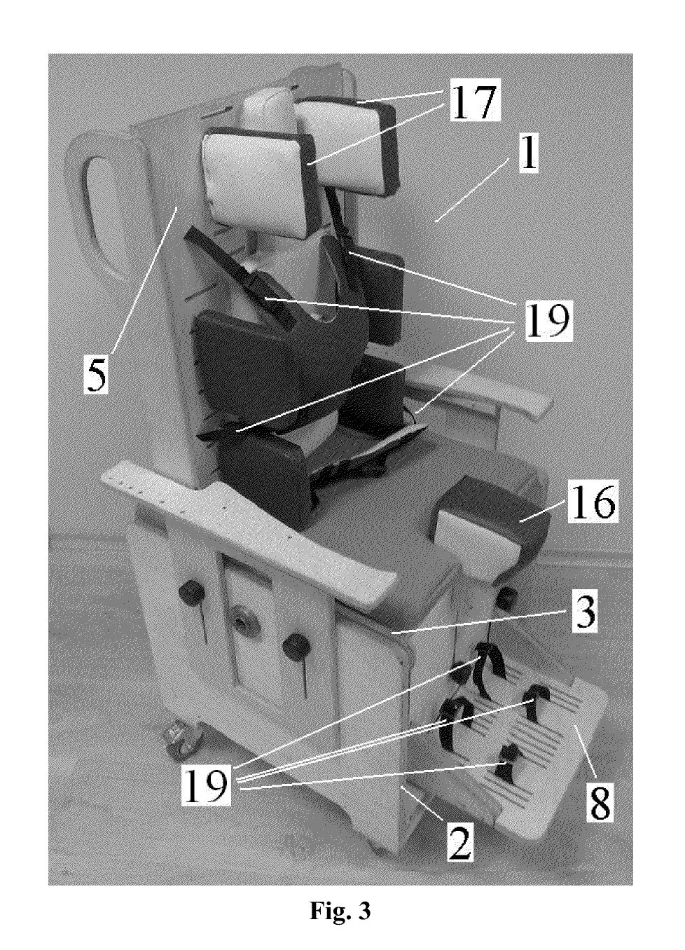

FIG. 3 shows the corresponding belts (19), intended for chest, hips and foot fixation.

It is necessary to emphasize that the mentioned chair has not only work and rest positions, but also a wide range of positions ranging from fully sitting to almost lying position; in any of these positions the chair can be easily and reliably fixed by using the worm shaft adjustment mechanism.

The whole construction of the chair (1) (that may come into contact with a person body) or the bigger part of it can be made of various materials: plastic, wood, metal, wood imitation, etc., however, wood is preferred as an ecological material.

1. A chair, intended for people with disabilities, especially in case of cerebral paralysis, consisting of the chair frame, seat, backrest and footstool, wherein the chair has:
the double frame, consisting of stationary external chair frame (2) and able to move (moving) internal chair frame (3), where
the external chair frame (2) is put on the ground and functions as a chair basis;
the internal chair frame (3) which is connected with the external frame, by using the main connecting axle (4), and is able to be rotated around the main connecting axle (4);
the worm shaft adjustment mechanism,
consisting of the stationary connecting part (10), vertical worm shaft (11) and the horizontal worm shaft (12),
integrated to the double frame construction and
ensuring smooth and exact adjustment of sitting part length and rotation of the internal chair frame (3) around the main connecting axle (4) in respect of the external chair frame (2) with the aim to ensure even (smooth) and exact turn of the chair's (1) backrest (5) with sitting part (6) and with footstool (8) position/change from the sitting/work position to half lying/rest position or vice versa, where
the stationary connecting part (10), mounted to the stationary external chair frame, functions as a vertical worm shaft bearing;
the vertical worm shaft (11), connected to the stationary connecting part (10), horizontal worm shaft (12) and internal chair frame (3), can be rotated around its axle and, depending on the rotation direction, can be moved forth or back, in this way making the position of the internal chair frame (3) to be changed (14) and fixed in respect of the external frame (2);
the horizontal worm shaft (12), connected to the axle (13) and the seat (6), can be rotated around its axle and, depending on its rotating direction, can be moved forth and back, in this way making the seat depth position to be changed (7) and fixed;
the axle (13) of the internal frame is mounted between the vertical worm shaft (11) and horizontal worm shaft (12), acting as a bearing for the worm shafts (11, 12);
and the guides,
ensuring the smooth movement of the system sliding parts, on which all the sliding parts of the chair (1) construction are mounted;
where
on the internal chair frame (3) is mounted:
chair backrest (5),
sliding seat (6), adjusted (7) according to the height/build of the person, and
footstool (8), adjusted (9) according to the height/build of the person.

2. The chair, intended for people with locomotor disability, according to claim 1, wherein the chair has the retaining mechanism, mounted on the front part of the chair (1) close to the footstool (8) in respect of the internal frame (3), which (mechanism) ensures easy and smooth change of the footstool (8) and seat (6) positions.

3. The chair, intended for people with locomotor disability, according to claim 1, wherein the chair has the wheels, mounted to the external frame (2) of the chair (1), which are intended for the movement of the chair (1) in any direction needed.

4. The chair, intended for people with locomotor disability, according to claim 1, wherein the angle of 90°, the angle close to 90° or other variable or stationary angle according (conforming) to the medical or other requirements is kept between the chair seat (6) and the plane of the backrest (5), also between the chair seat (6) and the vertical part of the footstool, as well as between the vertical and horizontal (moving) parts of the footstool.

5. The chair, intended for people with locomotor disability, according to claim 1, wherein the chair (1) construction has a removable abduction (restriction) device (16), intended for keeping person (child) legs in the required position.

6. The chair, intended for people with locomotor disability, according to claim 1, wherein the chair (1) construction has the corresponding engines, additional mechanics, electronics and control section(s) with which the person (child) sitting in the chair can change the position of the chair according to his needs.

7. The chair, intended for people with locomotor disability, according to claim 1, wherein the construction parts of the mentioned chair (1) are made of at least one of, plastic, wood, metal and imitation materials.

8. The chair, intended for people with locomotor disability, according to claim 1, wherein all or most of the chair (1) parts that may come into contact with people body are made of wood.

9. The chair, intended for people with locomotor disability, according to claim 1, wherein the chair has the belts (19), intended for the fixation of the chest, hips or foot of a person and/or corresponding holders (17) that support the body of the child: head and torso.

10. The chair, intended for people with locomotor disability, according to claim 2, wherein the chair has the wheels, mounted to the external frame (2) of the chair (1), which are intended for the movement of the chair (1) in any direction needed.

11. The chair, intended for people with locomotor disability, according to claim 2, wherein the angle of 90°, the angle close to 90° or other variable or stationary angle according (conforming) to the medical or other requirements is kept between the chair seat (6) and the plane of the backrest (5), also between the chair seat (6) and the vertical part of the footstool, as well as between the vertical and horizontal (moving) parts of the footstool.

12. The chair, intended for people with locomotor disability, according to claim 3, wherein the angle of 90°, the angle close to 90° or other variable or stationary angle according (conforming) to the medical or other requirements is kept between the chair seat (6) and the plane of the backrest (5), also between the chair seat (6) and the vertical part of the footstool, as well as between the vertical and horizontal (moving) parts of the footstool.

13. The chair, intended for people with locomotor disability, according to claim 2, wherein the chair (1) construction has a removable abduction (restriction) device (16), intended for keeping person (child) legs in the required position.

14. The chair, intended for people with locomotor disability, according to claim 3, wherein the chair (1) construction has a removable abduction (restriction) device (16), intended for keeping person (child) legs in the required position.

15. The chair, intended for people with locomotor disability, according to claim 4, wherein the chair (1) construction has a removable abduction (restriction) device (16), intended for keeping person (child) legs in the required position.

16. The chair, intended for people with locomotor disability, according to claim 2, wherein the chair (1) construction has the corresponding engines, additional mechanics, electronics and control section(s) with which the person (child) sitting in the chair can change the position of the chair according to his needs.

17. The chair, intended for people with locomotor disability, according to claim 3, wherein the chair (1) construction has the corresponding engines, additional mechanics, electronics and control section(s) with which the person (child) sitting in the chair can change the position of the chair according to his needs.

18. The chair, intended for people with locomotor disability, according to claim 4, wherein the chair (1) construction has the corresponding engines, additional mechanics, electronics and control section(s) with which the person (child) sitting in the chair can change the position of the chair according to his needs.

19. The chair, intended for people with locomotor disability, according to claim 5, wherein the chair (1) construction has the corresponding engines, additional mechanics, electronics and control section(s) with which the person (child) sitting in the chair can change the position of the chair according to his needs.

20. The chair, intended for people with locomotor disability, according to claim 2, wherein the construction parts of the mentioned chair (1) are made of at least one of, plastic, wood, metal and imitation materials.
